(19) United States
(12) Patent Application Publication
(10) Pub. No.: US 2013/0279310 A1
(43) Pub. Date: Oct. 24, 2013

(54) ANTIREFLECTION COATING FOR SLIDER

(71) Applicant: SEAGATE TECHNOLOGY LLC, Cupertino, CA (US)

(72) Inventors: Lijuan Zhong, Eden Prairie, MN (US); Scott Olson, Eagen, MN (US)

(73) Assignee: SEAGATE TECHNOLOGY LLC, Cupertino, CA (US)

(21) Appl. No.: 13/784,617

(22) Filed: Mar. 4, 2013

Related U.S. Application Data
(60) Provisional application No. 61/637,459, filed on Apr. 24, 2012.

(51) Int. Cl. G02B 1/11; G11B 13/04

(52) U.S. Cl. CPC G02B 1/11; G11B 13/04
USPC 369/13.02; 427/127

(57) ABSTRACT

In accordance with one embodiment, a method is disclosed that comprises disposing an antireflection material in juxtaposition with a top surface of a slider. In accordance with another embodiment, a method is disclosed that comprises disposing an antireflective material between a facet edge of a laser and an incident surface of a waveguide. In yet another embodiment, an apparatus is disclosed that comprises a slider and an antireflection material in juxtaposition with a top surface of the slider.

This application claims the benefit under 35 U.S.C. section 119 of U.S. provisional patent application no. 61/637,459 filed on Apr. 24, 2012 and entitled “Slider Antireflection Coating for HAMR Light Delivery Efficiency” which is hereby incorporated by reference in its entirety and for all purposes.

### BACKGROUND

Laser mounted write devices are sometimes used to record information on storage media. For example, in the technology of magnetic storage media, a technique known as heat assisted magnetic recording (HAMR) can utilize a laser or other light source to heat a portion of the magnetic media prior to a write operation being performed. The light source heats the targeted storage location and thus makes the write operation more efficient and accurate. In order to direct the light to a targeted spot on the magnetic media, a waveguide can be used.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following more particular written Detailed Description of various implementations and implementations as further illustrated in the accompanying drawings and defined in the appended claims.

In accordance with one embodiment an apparatus is disclosed that comprises a slider and an antireflection material in juxtaposition with a top surface of the slider. A method may be utilized to manufacture a slider by disposing an antireflection material in juxtaposition with a top surface of a slider, in accordance with yet another embodiment. Also, an antireflective material may be disposed between a facet edge of a laser and an incident surface of a waveguide, in accordance with yet another embodiment.

These and various other features and advantages will be apparent from a reading of the following detailed description.

### BRIEF DESCRIPTION OF THE DRAWINGS

A further understanding of the nature and advantages of the present technology may be realized by reference to the figures, which are described in the remaining portion of the specification.

FIG. 1 illustrates an example of a disk drive system using a submount assembly for directing light at the surface of a waveguide, in accordance with one embodiment.

FIG. 2 illustrates a slider with a laser submount assembly in accordance with one embodiment.

FIG. 3 illustrates a side view of a slider with an anti-reflective coating on the slider and above the top surface of the waveguide, in accordance with one embodiment.

FIG. 4 illustrates a flow chart for disposing an antireflection material in accordance with one embodiment.

FIG. 5 illustrates a more detailed flow chart illustrating another embodiment of disposing an antireflection material in juxtaposition with a waveguide surface, in accordance with one embodiment.

FIG. 6 illustrates yet another embodiment for disposing an antireflection material between a laser facet edge and an incident surface of a waveguide, in accordance with one embodiment.

FIG. 7 illustrates a graph showing the anti-reflective (ARC) effects of MgF₂, in accordance with one embodiment.

FIG. 8 illustrates a graph showing the anti-reflective (ARC) effects of SiO₂, in accordance with one embodiment.

### DETAILED DESCRIPTION

Embodiments of the present technology are disclosed herein in the context of a disc drive system. However, it should be understood that the technology is not limited to a disc drive system and could readily be applied to other technology systems as well.

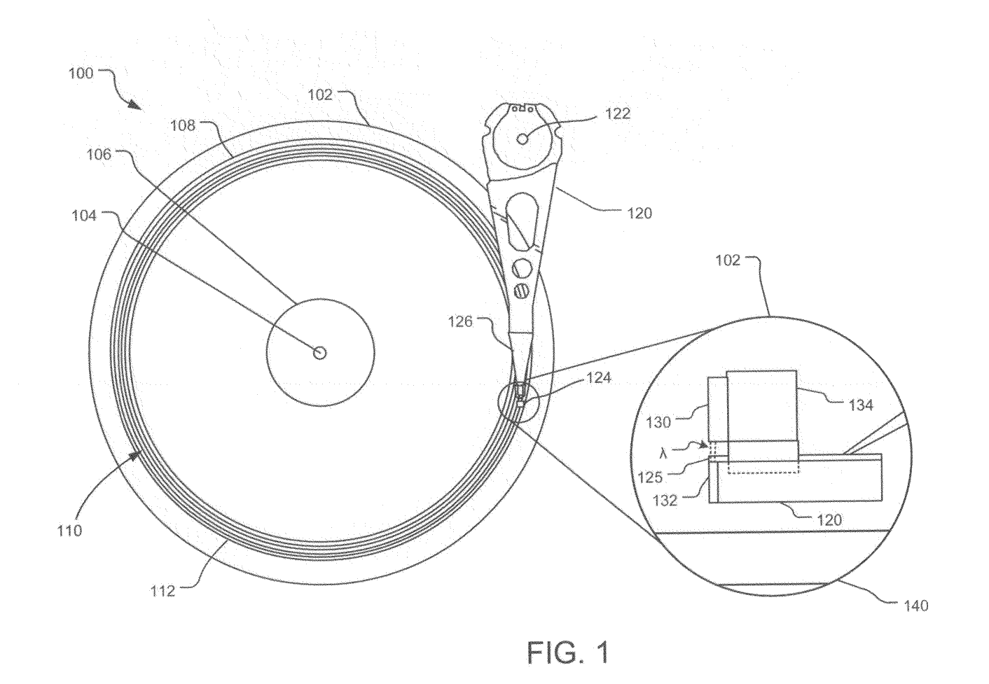

With reference now to FIG. 1, an example of a disc drive system in accordance with one embodiment is shown. A disc drive system is but one example where disclosed technology may be utilized. FIG. 1 illustrates a perspective view 100 of an example transducer head using heat assisted magnetic recording. A disc 102 rotates about a spindle center or a disc axis of rotation 104 during operation. The disc 102 includes an inner diameter 106 and an outer diameter 108 between which are a number of concentric data tracks 110, illustrated by circular lines.

Information may be written to and read from recorded magnetic domains 112 on the disc 102 in different data tracks 110. A transducer head 124 is mounted on an actuator assembly 120 at an end distal to an actuator axis of rotation 122. The transducer head 124 flies in close proximity above the surface of the disc 102 during disc operation. The actuator assembly 120 rotates during a seek operation about the actuator axis of rotation 122 positioned adjacent to the disc 102. The seek operation positions the transducer head 124 over a target data track of the data tracks 110.

The exploded view 140 shows slider 120 attached to a laser submount assembly having a laser light source 130 (e.g., a laser diode) or other light source (e.g., a light emitting diode (LED)). The laser submount assembly 134 is shown integrated with the slider 120. In one implementation, the integration can be accomplished utilizing a bonding pad and/or bonding cavity (designated by the dashed lines).

The slider 120 can include a write section (not shown) having a main write pole magnetically coupled to a return or opposing pole by a yoke or pedestal. A magnetization coil surrounds the yoke or pedestal to induce magnetic write pulses in the write pole. In other implementations, the slider 120 may be constructed without a yoke or return pole. The slider 120 may also include one or more read sensors (not shown) for reading data off of the media.

Light “λ” (lambda) from the laser light source 130 is shown passing through an antireflective coating 125 so as to be incident on a waveguide 132 on the trailing edge of the slider 120. Using the waveguide, the light can then be redirected and/or focused on a point on the media in close proximity to the write pole on the slider 120. A near-field transducer (NFT) may also be mounted on the slider 120 to further concentrate the light on the point on the media 108. In another implementation, one or more of the laser light source 130, waveguide 132, mirrors (not shown), and/or NFTs (not shown) are mounted on an area of the slider 120 other than the trailing surface.

By using a laser coupled with the write head, a heat-assisted magnetic recording (HAMR) recording technique can be utilized. A HAMR system allows the light from the laser to heat a portion of the magnetic recording medium prior to a write operation being performed. The light from the laser can be focused via a waveguide on a precise location of the magnetic medium prior to the write head performing a write operation. This allows improved areal density to be achieved. A HAMR head thus allows the laser to be situated precisely so that the laser can be directed at the desired location on the magnetic recording medium. One way of mounting the laser on the write head is to utilize a submount device. This allows the laser to be mounted on the slider. A laser diode can be utilized as the laser in accordance with one embodiment.

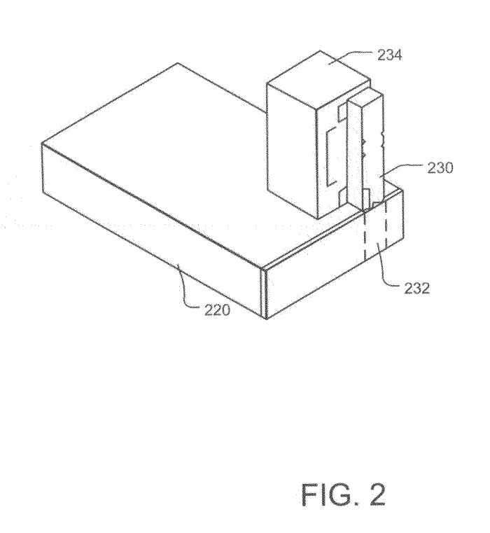

In accordance with one embodiment and as discussed in more detail below, an antireflective material can be utilized on the surface of the slider to allow the light emitted from the light source (e.g., laser or LED) to be utilized by the waveguide. Referring now to FIG. 2, an example of a laser-on-slider can be seen. A laser submount 234 is shown integrated with a laser diode 230. A submount can serve as a mounting piece for the laser with respect to the slider. For example, the submount can be utilized to mount a laser to a slider without requiring the laser to actually touch the slider. The laser diode 230 is positioned over a waveguide 232 that is disposed within a slider 220.

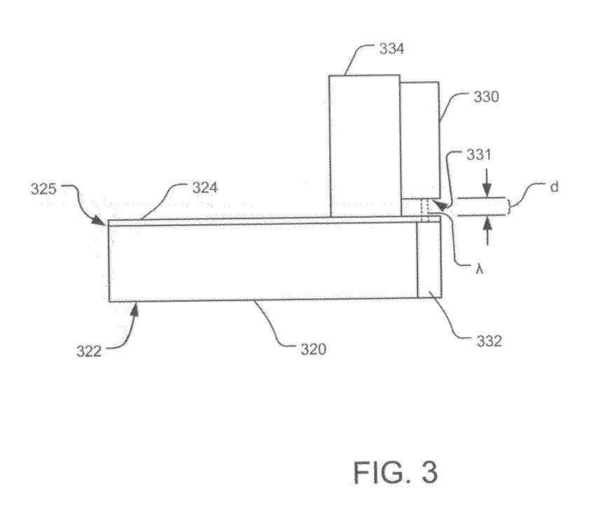

Referring now to FIG. 3, a laser on slider submount assembly is shown. A slider 320 is shown coupled with a submount 334. The submount 334 holds a laser 330, such as a laser diode, in close proximity to a waveguide 332. The laser is preferably positioned in juxtaposition with the waveguide 332 so that there is little loss of light quality between the point where light is emitted from laser 330 and received by waveguide 332. However, in most instances an air gap will be present between the laser facet edge 331 and the receiving surface of the waveguide 332.

One characteristic of the waveguide that can diminish the quality and effectiveness of the device is a reflective surface of the waveguide. The reflective surface of the waveguide causes some of the incident light from the laser to be reflected from the surface of the waveguide rather than transmitted through the waveguide material. This can lead to diminished efficiency for the device.

FIG. 3 shows laser 330 directing light designated as “λ” (lambda) toward the surface of waveguide 332. The air gap is designated as distance “d”. Even if the air gap is a small distance, light reflection can still take place. Furthermore, because the positioning of the laser can vary by a small degree, the amount of light incident and transmitted through the waveguide can vary based on the positioning of the laser. Furthermore, light reflection may vary due to environmental conditions. An antireflection material 325 is shown disposed on the surface of the slider. It extends across the entire surface of the slider so as to also cover the top surface of the waveguide.

In accordance with one embodiment, the problems caused by reflection at the surface of the waveguide can be diminished by utilizing an anti-reflection coating in juxtaposition with the surface of the waveguide. For purposes of this disclosure, the slider 320 shown in FIG. 3 has a bottom surface 322 which is the air bearing surface and a top surface 324 which is sometimes referred to as the waveguide surface of the slider. In accordance with one embodiment, an anti-reflection coating can be deposited on the top surface of the waveguide. Moreover, the anti-reflection coating can be deposited over a larger portion of the slider or even over the entire surface of the slider.

The coating process can take place prior to mounting the laser submount assembly. The coating can be achieved utilizing photolithography to deposit layers in order to fabricate the anti-reflection coating. For example, the process could include the steps of: bar mount, photo lithograph, deposition, and resist lift-off.

A variety of coatings could be utilized for their antireflective properties. For example, one might utilize MgF₂, SiO₂, or Al₂O₃ as the antireflective coating.

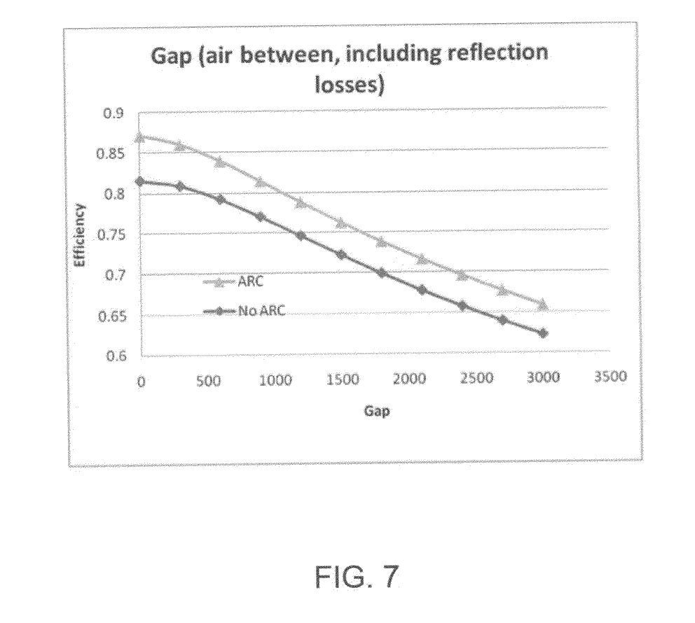

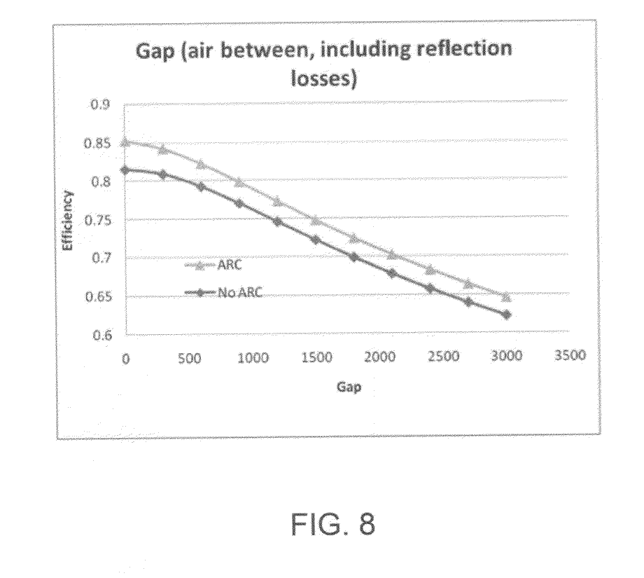

FIG. 7 and FIG. 8 illustrate modeled results for an air gap between a laser facet edge and waveguide surface for MgF₂ and SiO₂ respectively. As can be seen from FIG. 7 and FIG. 8, the antireflective coatings (ARC) improve the light coupling efficiency between the laser and waveguide/slider.

Once the antireflective coating is disposed on the slider, the laser submount assembly can be positioned on the slider. This allows the laser to be positioned over the waveguide portion of the slider. Moreover, it allows the laser to be positioned above the antireflective coating of the slider.

In accordance with one embodiment, one might choose to utilize an intermediate layer of material between the antireflective coating and the top surface of the waveguide. Therefore, it should be understood that the antireflective coating need only be placed in juxtaposition with the waveguide surface so as to be operative to reduce reflection. It is not a requirement in all embodiments that the antireflective material be placed directly on the waveguide surface itself.

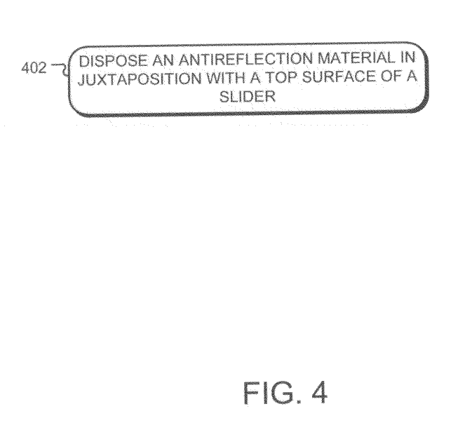

Referring now to FIG. 4, a flowchart illustrating a method in accordance with one embodiment can be seen. The flowchart in FIG. 4 shows a single operation block which states that an anti-reflection material is disposed in juxtaposition with a top surface of a slider.

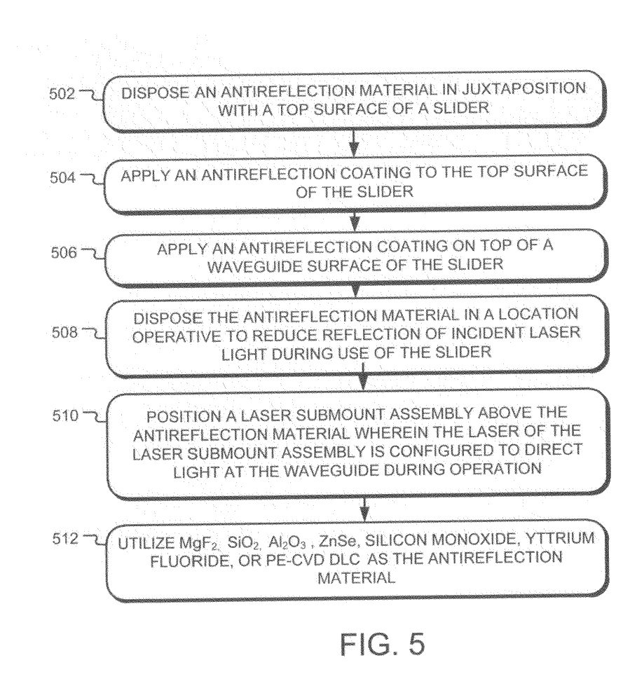

A more detailed embodiment is illustrated by the flowchart in FIG. 5. In operation block 502, an anti-reflection material is disposed in juxtaposition with a top surface of a slider. Operation block 504 shows that an anti-reflection coating can then be applied to the top surface of the slider. Moreover, operation block 506 illustrates that the anti-reflection coating could just be applied to the top of the waveguide surface of the slider. Similarly, operation block 508 illustrates that the anti-reflection material could simply be disposed in a location that is operative to reduce reflection of incident light during use of the slider.

Operation block 510 shows that a laser submount assembly can be positioned above the anti-reflection material. The laser of the laser submount assembly can be configured to direct light at the waveguide during operation. Operation block 512 shows that MgF₂, SiO₂, or Al₂O₃, ZnSe (moth eye), silicon monoxide, yttrium fluoride, or PE-CVD DLC can be utilized as the antireflection material. In one embodiment, one might choose to use two or more layers of these materials so as to utilize two or more of these materials. For example, one can use alternating layers of high and low index materials.

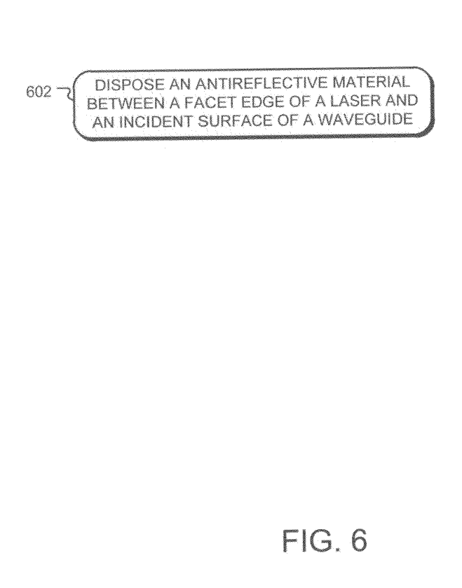

Referring now to FIG. 6, yet another embodiment can be seen. Operation block 602 illustrates that one can dispose an antireflective material between a facet edge of a laser and an incident surface of a waveguide. As noted above, this allows one to reduce reflection of the incident laser light incident at the waveguide.

It is noted that many of the structures, materials, and acts recited herein can be recited as means for performing a function or step for performing a function. Therefore, it should be understood that such language is entitled to cover all such structures, materials, or acts disclosed within this specification and their equivalents, including any matter incorporated by reference.

It is thought that the apparatuses and methods of embodiments described herein will be understood from this specification. While the above description is a complete description of specific embodiments, the above description should not be taken as limiting the scope of the patent as defined by the claims.

What is claimed is:

1) An apparatus comprising:
a slider;
an antireflection material disposed on a top surface of the slider opposite to an air bearing surface of the slider and in a predetermined position that reduces reflection of incident light from a heat assisted magnetic recording light source.

2) The apparatus as claimed in claim 1 wherein the antireflection material comprises:
an antireflection coating on the top surface of the slider.

3) The apparatus as claimed in claim 1 wherein the antireflection material comprises:
an antireflection coating on top of a waveguide surface.

4) The apparatus as claimed in claim 2 wherein the antireflection material comprises:
antireflection material disposed in a location operative to reduce reflection of incident light from the heat assisted magnetic recording light source during a write operation of the slider.

5) The apparatus as claimed in claim 1 and further comprising:
a heat assisted magnetic recording light source positioned above the antireflection material.

6) The apparatus as claimed in claim 1 and further comprising:
a laser submount assembly positioned above the antireflection material wherein the laser of the laser submount assembly is configured to direct light at a waveguide during operation.

7) The apparatus as claimed in claim 1 wherein the antireflection material comprises:
MgF₂ as the antireflection material.

8) The apparatus as claimed in claim 1 wherein the antireflection material comprises:
SiO₂ as the antireflection material.

9) The apparatus as claimed in claim 1 wherein the antireflection material comprises:
Al₂O₃ as the antireflection material.

10) The apparatus as claimed in claim 1 wherein the antireflection material has a predetermined thickness that reduces reflection of the incident light from a heat assisted magnetic recording light source by a predetermined amount.

11) A method comprising:
disposing an antireflection material on a top surface of a slider opposite to an air bearing surface of the slider and in a pre-determined position that reduces reflection of incident light from a heat assisted magnetic recording light source.

12) The method as claimed in claim 11 wherein the disposing the antireflection material on the top surface of the slider comprises:
applying an antireflection coating to the top surface of the slider.

13) The method as claimed in claim 11 wherein the disposing the antireflection material on the top surface of the slider comprises:
applying an antireflection coating on top of a waveguide surface.

14) The method as claimed in claim 12 wherein the applying the antireflection coating to the top surface of the slider comprises:
disposing the antireflection material in a location operative to reduce reflection of incident light from the heat assisted magnetic recording light source during a write operation of the slider.

15) The method as claimed in claim 11 and further comprising:
positioning the heat assisted magnetic recording light source above the antireflection material.

16) The method as claimed in claim 11 and further comprising:
positioning a laser submount assembly above the antireflection material wherein the laser of the laser submount assembly is configured to direct light at a waveguide during operation.

17) The method as claimed in claim 11 wherein the disposing the antireflection material on the top surface of the slider comprises:
utilizing MgF₂ as the antireflection material.

18) The method as claimed in claim 11 wherein the disposing the antireflection material on the top surface of the slider comprises:
utilizing SiO₂ as the antireflection material.

19) The method as claimed in claim 11 wherein the disposing the antireflection material on the top surface of the slider comprises:
utilizing Al₂O₃ as the antireflection material.

20) A method comprising:
disposing an antireflection material on a slider in a position located during operation of the slider between a facet edge of a heat assisted magnetic recording light source and an incident surface of a waveguide.
